(19) United States
(12) Patent Application Publication
(10) Pub. No.: US 2007/0084550 A1
(43) Pub. Date: Apr. 19, 2007

(54) Method to increase the fusion of radio-frequency welds between dissimilar materials

(76) Inventors: Adam S. Epstein, Wellesley, MA (US); Thomas L. Rooney, Amherst, MA (US); Stephen J. Wiater, Southwick, MA (US)

Correspondence Address: CANTOR COLBURN, LLP, 55 GRIFFIN ROAD SOUTH, BLOOMFIELD, CT, 06002, US

(21) Appl. No.: 11/545,630

(22) Filed: Oct. 10, 2006

Related U.S. Application Data
(60) Provisional application No. 60/725,056, filed on Oct. 7, 2005.

(51) Int. Cl. B29C 65/04; B29C 65/06

(52) U.S. Cl. 156/272.8

(57) ABSTRACT

A practical method to increase the fusion of radio-frequency welds between two structures made of dissimilar materials by introduction of a bonding layer between the two structures. The bonding layer must be an RF-weldable material that welds or bonds well to both of the materials from which the respective structures are made. The bonding layer may be introduced by coating one of the structures with the bonding material or by forming the bonding material into a sleeve which is placed over one of the structures.

### CROSS-REFERENCE TO RELATED APPLICATIONS

This application claims the benefit of U.S. provisional patent application 60/725,056, the entire contents of which of incorporated herein by reference.

### FIELD OF THE INVENTION

This invention relates to radio-frequency (RF) welding, also known as dielectric welding or high-frequency welding, and relates more specifically to a practical method to increase the fusion of radio-frequency welds between structures made of dissimilar materials.

### BACKGROUND

Joining processes are extensively used in the plastic medical device industry because a finished medical assembly is normally to complex to mold in one piece, or because different materials must be used within a finished assembly. Welding processes are most used for thermoplastics applications in which the part joint surfaces are melted, allowing the polymer chains to fuse together, forming a strong weld. Another method commonly used in joining plastics is chemical bonding, in which a separate material (adhesive) is applied between two surfaces to provide strong bonds with these two surfaces, respectively. In addition, mechanical fastening is also used when disassembly or reassembly is required.

RF welding has traditionally been used to weld two identical dipolar thermoplastics, such as Polyvinyl Chloride (PVC) to PVC. The process uses high frequency (13 to 100 MHz, typically 27.12 MHz) electromagnetic energy to generate heat in dipolar materials, resulting in melting and forming a weld after cooling. RF welding is one of the commonly used plastic welding processes in medical applications, such as blood bags and colostomy bags.

The advantages of this type of welding are that it is simple, low cost, has a short cycle time, and is suitable for large flat joints. RF welding uses simple, compact equipment. No solvents, adhesive or specific join design for welding are required. The weld appearance is very good, with very little flashing. Additionally, RF welding provides a tear seam, so that sealing and cutting can be combined into a single step. Therefore, RF welding is a fast, clean, and relatively inexpensive welding process.

In RF welding, the strength of the welds depends on the fusion of polymer chains at the interface. Typically, welding two identical materials provides the best fusion. In addition, the process is also sensitive to dielectric properties, such as dielectric constant and loss factor, as well as the rigidity and the melt temperature, or Tg, of the materials to be welded. Therefore, the process is very limited by materials. Non-dipolar or high melt temperature materials such as polyolefin, and polycarbonate, which are widely used in automotive, medical devices and other applications, are generally not weldable. Additionally, forming strong welds when welding two or more dissimilar materials is another challenge when performing RF welding.

The RF welding process is conducted using a welding press consisting of two platens—a moveable one, and a fixed one, also called a bed. The parts to be welded are placed between a set of metal dies, or electrodes, mounted on the platens. The press lowers the moveable platen, and a preset amount of pressure is applied to the area to be joined, typically by compressed air. During the process, an intensive high-frequency electric field, generated by an RF generator, is applied to the parts to be welded. In such an electric field, strong dipolar polymers, such as polyvinyl chloride (PVC), thermoplastic polyurethane (TPU), polyamide (PA), polyvinylidene chloride (saran), cellulose acetate, and polyethylene terephthalate (PET), undergo a dipolar polarization process. The resultant dipoles in the polymer chains tend to orient in the field direction. As the high-frequency electric field is made to rapidly reverse, the dipoles try to align with the rapidly reversing field, and orientation becomes out-of-phase due to restricted motion of polymer chains. The imperfect alignment causes internal molecular friction heating. The generated heat then melts the joint interface of the parts. Consequently, the molten interfaces enhance the degree of fusion and entanglements of polymer chains to produce a strong weld. Thereafter, the joint cools under pressure. At the appropriate time, the press opens and the finished assembly is released.

Non-dipolar or weak dipolar polymers, and polymers such as polyolefin and polystyrene (PS) are not considered compatible with the RF welding method because dipoles are not able to be formed by these materials in a high-frequency electric field. As a result, there is no molecular motion generated in response to the rapid reversing field.

In addition, some rigid materials, or materials with high melt temperatures (Tgs) are also not considered to be candidates for RF welding because this technique is either not able to melt the materials effectively, or the fusion of the melt is poor. Polycarbonate (PC) is a good example of such a material, as is PVC. Although PVC was the first material used in the RF process, a study showed that rigid PVC produces much weaker RF welds than flexible PVC. Rigid PVC did not weld well to itself because the material did not melt or melt completely through before a weld could form.

It is worth noting that, besides the inherent properties of materials, the thickness of the part to be welded and the applied clamping pressure are two key factors which impact on the strength of the welds produced in RF welding. A thick part separates the electrodes and reduces the intensity of the electric field, resulting in less effective heating. For RF welding, part thickness usually ranges from 0.50 mm to 1.90 mm, depending on the nature of the materials to be welded. For very thin films, even polycarbonate may be considered weldable. High clamping pressure facilitates heating and melt flow to form a strong joint weld.

Although the RF welding process has great advantages in terms of production, a relatively narrow range of materials usable in RF welding limits the utilization and development of the process.

It has been a trend in the automotive industry to replace PVC parts using thermoplastic olefins (TPOs). Traditionally, some PVC parts are welded using an RF welding process. TPOs, however, are non-dipolar materials and are not RF-weldable. In order to overcome the obstacle, TPO/dipolar material blends have been developed for the RF welding process. In a study, a composite of polyaniline (PAN) and high-density polyethylene (HDPE) was used for welding. PAN is a conductive polymer, and has great responsiveness to a high frequency reversing electric field. HDPE effectively served as an insulator to separate PAN particles, resulting in a reduction of conductivity as compared to that material alone. The low conductive composite did heat very well in adiabatic heating. The composite could be heated up to a temperature of 275° C. and formed welds with good joint strength.

By blending of dipolar materials with non-polar materials, these materials are able to be heated by RF, resulting in an expansion of the number and types of materials which can be effectively welded using the RF welding process. In these cases, the parts to be welded together are made from the same material. Therefore, the molecular fusion of the melt is not a serious problem. However, in some cases, especially in the medical device industry, a final assembly consists of two parts made from dissimilar materials. Compatibility and molecular fusion in melt flow become essential for a strong weld of these two parts.

There is a need for a method which can increase the fusion of RF welds used to join parts made from dissimilar materials.

### SUMMARY OF THE INVENTION

An embodiment of the method of the invention provides a practical method of increasing the fusion of RF welds used to join two structures of dissimilar materials by the introduction of a bonding layer between the two structures. The bonding layer may be provided by applying a coating or sleeve of RF-weldable material that is compatible with the materials of both structures to the joining surface of one of the structures which is made of a typically non-weldable material.

### BRIEF DESCRIPTION OF THE DRAWINGS

In the drawings, in which like reference numerals indicate corresponding parts in all views:

FIG. 1 is a perspective view of a rigid structure prior to being dip-coated in a first and second embodiment of the invention.

FIG. 2 is a perspective side view of the rigid structure of FIG. 1 being dipped in a slurry of a compatibilizer solution.

FIG. 3 is a perspective side view of the rigid structure of FIG. 1 with a coating thereon.

FIG. 4 is a perspective view of the rigid structure of FIG. 3 with a flexible structure secured thereto.

FIG. 5 is a perspective view of a compatibilizer sleeve of a third embodiment of the invention and the mandrel on which it is formed.

FIG. 6 is a perspective view of the compatibilizer sleeve of FIG. 5 removed from the mandril.

FIG. 7 is a perspective side view of a rigid structure with the compatibilizer sleeve of FIG. 6 mounted thereon.

FIG. 8 is a perspective side view of the rigid structure and compatibilizer sleeve of FIG. 7 with a flexible structure secured thereto.

### DESCRIPTION OF THE PREFERRED EMBODIMENTS

A description of the preferred embodiments of the present invention will now be had by way of example, and not limitation, with reference to FIGS. 1 through 8.

Surgical apparatuses, such as access devices and balloon dissectors, which include a flexible structure secured to a rigid structure, require the joining of dissimilar materials to form final assemblies. As an example, during laparoscopic procedures, a cannula supporting an inflatable dissection balloon on its distal end is sometimes used to separate tissue. It is important that a fluid seal is maintained between the dissection balloon and the cannula. This device requires a rigid plastic (the cannula) and a flexible plastic (the balloon) to be assembled hermetically in a single device. In such devices, the rigid cannula is generally made of polycarbonate, which is well suited to the job by virtue of its biocompatibility, high rigidity, and high toughness. The balloon dissector is made from flexible materials. Thermoplastic polyurethane (TPU) or laminar composites with TPU as outer, or skin, layers are widely used because of their good biocompatibility and easy processibility.

Although solubility parameters of polycarbonate and TPU are very close and those two materials are considered compatible, polycarbonate, which has high rigidity and high Tg, generally does not weld to TPU very well, resulting from poor melt fusion. In addition, polycarbonate is not considered RF-weldable.

In order to facilitate the bonding between these two dissimilar materials, a thin, RF-weldable bonding layer can be introduced. This thin bonding layer should meet two criteria: 1) the bonding layer must be able to weld or bond to both of the dissimilar materials (which are polycarbonate and TPU in our example); and 2) the bonding layer should be RF weldable. A recent study shows that heat is generated more effectively through adhesive layers than through bulky materials because adhesive is made of materials with relatively low molecular weight. Short molecular chains provide high mobility and great free volume, resulting in effective heat generation. In addition, high mobility of the molecules facilitates chain penetration or fusion producing welds with good strength.

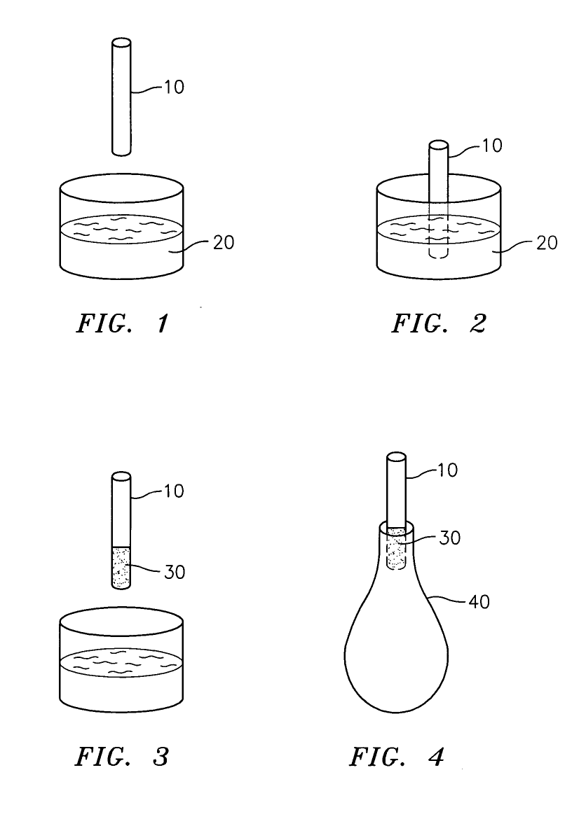

The technique will be described in reference to FIGS. 1-4. According to the criteria above, for the example of the polycarbonate cannula 10 and the balloon 40 of TPU, two-component liquid polyurethane is a suitable bonding material. First, a solution 20 of two-component liquid polyurethane mixed with a solvent, such as tetraydrofuran (THF), cyclohexanone, or a combination of the two, was made (FIG. 1). Then a distal end of the polycarbonate cannula 10 was dipped into this solution for several seconds to allow the solution (FIG. 2) to form a coating 30 thereon (FIG. 3). Because the solvent is a solvent of polycarbonate, it caused the rigid polycarbonate surface of the cannula 10 to soften and swell, facilitating the penetration of polyurethane into the polycarbonate. Thereafter, the coating 30 was allowed to cure and the THF, being volatile, was released via off-gassing, perhaps accelerated with heat, leaving behind the polyurethane bonded to and coating the polycarbonate of the cannula 10. Because of the good compatibility of polycarbonate and polyurethane resulting from this process, the interface of polycarbonate and polyurethane had good strength. By virtue of the coating 30, the joint surface of the cannula was altered to be a material which is weldable and comprises polyurethane, the same material from which the balloon dissector 40 to be welded thereto is made. This simple process enables the dissimilar materials of the polycarbonate of the cannula 10 and the TPU of the balloon dissector 40 to be RF welded together, resulting in a weld with a good joint strength (FIG. 4).

Another embodiment of the method of the invention involves using aliphatic polycarbonate-based TPU, such as CARBOTHANE® (produced by Noveon Inc.). CARBOTHANE® consists of both polycarbonate segments and TPU segments. This unique structure can be used as a bonding layer to make TPU and PC compatible, enhancing the strength of a weld between structures made of these two dissimilar materials.

CARBOTHANE® was dissolved into a solvent, such as THF, cyclohexanone or a combination thereof, to form a suspension mixture-like slurry 20 (FIG. 1). Afterward, a polycarbonate cannula 10 was dipped into the CARBOTHANE® slurry 20 (FIG. 2) to produce a coating 30 thereon with a thickness from 0.002″-0.006″ (FIG. 3). THF was used, not only to help CARBOTHANE® be coated onto the polycarbonate part, but also to swell the surface of the polycarbonate part, increasing the penetration of the CARBOTHANE®. Based on similarity theorem, the polycarbonate segments of the CARBOTHANE® fused into the polycarbonate part, leaving polyurethane segments outside, available to be welded to the TPU of the balloon dissector 40. Once the coating 30 was cured, with the solvent off-gassing due to its volatility, perhaps accelerated with heat, the coated cannula 10 was welded to the balloon dissector 40 (FIG. 4) using RF welding.

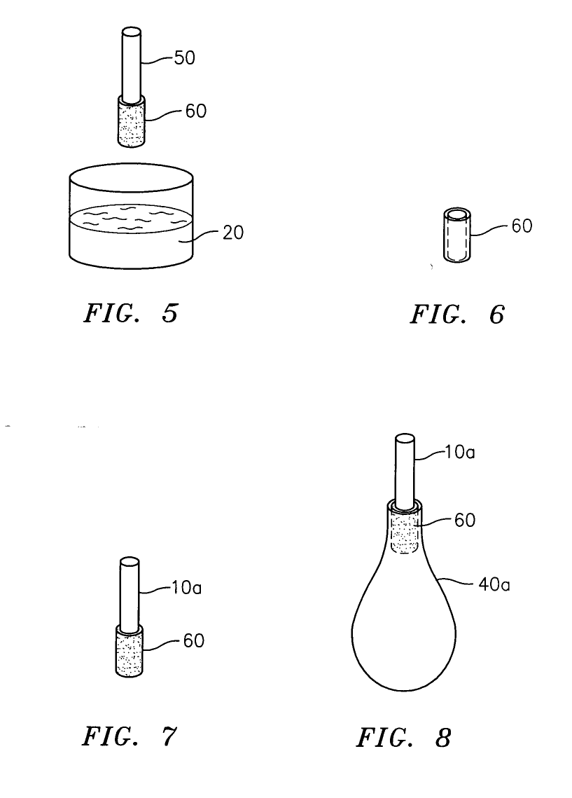

In a third embodiment of the method of the invention, described with reference to FIGS. 5-8, a compatibilizer sleeve 60 was fabricated by dipping a blown glass mandrel 50 into the slurry 20 described above, and then the volatile solvent was off-gassed (FIG. 5). The resulting sleeve 60 was then removed from the mandrel 50 (FIG. 6) and welded onto the polycarbonate cannula 10a (FIG. 7). Although the resulting cannula surface provided by the sleeve 60 had both PC and TPU elements, the high percentage of TPU provided a compatible surface to weld a flat die extruded film to, such as a balloon dissector 40a made of TPU (FIG. 8).

By introduction of a bonding layer, as outlined in the description and the embodiments detailed above, two structures made from dissimilar materials which normally provide poor weld strength, can be successfully joined by welding. In addition, by coating a part made from typically non-weldable materials with a compatible, weldable material, the part may be welded easily to another part. The technique not only improves the weld-joining processibility, but also gives much flexibility for material selection and part design as well.

While the technique of the invention has been discussed in terms of its suitability for RF welding, it can also be applied to other types of welding process, such as impulse welding and laser welding.

While this invention has been described with reference to one or more embodiments, it will be understood by those skilled in the art that various changes may be made and equivalents may be substituted for elements thereof without departing from the spirit or scope of this invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention.

What is claimed is:

1. A method for enabling two structures made from dissimilar materials to be welded to one another successfully, said method comprising:
providing two structures made, respectively, from dissimilar materials;
providing one of said two structures with a weldable bonding layer that is compatible for welding or bonding to each of said dissimilar materials;
welding the other of said two structures to said bonding layer.

2. The method of claim 1, wherein said providing one of said two structures with a weldable bonding layer comprises dipping at least a portion of said one of said two structures into a solution containing a solvent mixed with a weldable bonding material that is compatible for welding or bonding to each of said dissimilar materials to form a coating on said one of said two structures, then allowing the coating to cure as the solvent is released by off-gassing.

3. The method of claim 2, wherein allowing the coating to cure includes the application of heat to accelerate the curing process.

4. The method of claim 1, wherein said providing one of said two structures with a weldable bonding layer comprises dipping at least a portion of said one of said two structures into a solution containing a solvent mixed with a weldable bonding material that comprises a mixture of each of said dissimilar materials to form a coating on said one of said two structures, then allowing the coating to cure as the solvent is released by off-gassing.

5. The method of claim 4, wherein allowing the coating to cure includes the application of heat to accelerate the curing process.

6. The method of claim 1, wherein said providing one of said two structures with a weldable bonding layer comprises:
forming a sleeve on a mandrel by dipping said mandrel into a solution containing a solvent mixed with a weldable bonding material that is compatible for welding or bonding to each of said dissimilar materials to form a coating on said one of said two structures;
allowing the coating to cure as the solvent is released by off-gassing;
removing said sleeve from said mandrel; and
securing said sleeve to said one of said two structures by bonding or welding.

7. The method of claim 1, wherein said welding comprises RF welding.

8. The method of claim 1, wherein said welding comprises impulse welding.

9. The method of claim 1, wherein said welding comprises laser welding.

10. A method for enabling a first structure made of polycarbonate to be welded successfully to a second structure made of thermoplastic polyurethane, said method comprising:
providing a first structures made of polycarbonate and a second structure made of thermoplastic polyurethane;
forming a coating on said first structure by dipping it into a solution which comprises a solvent in combination with one of the group consisting of polyurethane and a mixture of polycarbonate segments and thermoplastic polyurethane segments, then allowing the coating to cure as the solvent is released by off-gassing; and
welding said second structure to said coating on said first structure.
